(19) United States
(12) Patent Application Publication
(10) Pub. No.: US 2022/0413746 A1
(43) Pub. Date: Dec. 29, 2022

(54) TRANSFER DEVICE, TRANSFER METHOD, AND TRANSFER PROGRAM

(71) Applicant: FUJIFILM CORPORATION, Tokyo (JP)

(72) Inventors: Michitaka KONDO, Tokyo (JP); Yutaka OISHI, Tokyo (JP); Takashi MIYAMOTO, Tokyo (JP); Terue WATANABE, Tokyo (JP); Koji MATSUMURA, Tokyo (JP); Yuko UNO, Tokyo (JP)

(21) Appl. No.: 17/822,807

(22) Filed: Aug. 29, 2022

Related U.S. Application Data
(63) Continuation of application No. PCT/JP2021/000908, filed on Jan. 13, 2021.

(30) Foreign Application Priority Data
Mar. 13, 2020 (JP) 2020-044486

(51) Int. Cl. G06F 3/06

(52) U.S. Cl. CPC G06F 3/0655; G06F 3/0604; G06F 3/0682

(57) ABSTRACT

A transfer device is a transfer device that distributes and transfers a plurality of pieces of data to a plurality of information processing devices that perform control to record data on a magnetic tape, in which the transfer device transfers data to the plurality of information processing devices such that the number of pieces of data is leveled between the plurality of information processing devices, and transfers a plurality of pieces of data of which a value indicating a probability that a plurality of pieces of data are read within a predetermined period is a threshold value or greater, to the same information processing device.

### CROSS-REFERENCE TO RELATED APPLICATIONS

This application is a continuation application of International Application No. PCT/JP2021/000908, filed on Jan. 13, 2021, the disclosure of which is incorporated herein by reference in its entirety. Further, this application claims priority from Japanese Patent Application No. 2020-044486, filed on Mar. 13, 2020, the disclosure of which is incorporated herein by reference in its entirety.

### BACKGROUND

### 1. Technical Field

The present disclosure relates to a transfer device, a transfer method, and a transfer program.

### 2. Description of the Related Art

A technique of using a data length to determine a storage node of a data storage destination in an object storage system provided with a plurality of storage nodes is disclosed (JP2014-203329A).

A technique of determining a storage of a file storage destination such that a file is evenly distributed to each storage in a case where the file is associated with the storage of the file storage destination in a system provided with a plurality of storages is disclosed (JP2004-252957A).

### SUMMARY

In the techniques disclosed in JP2014-203329A and JP2004-252957A, in a case where data is recorded in a plurality of storage devices, load distribution is performed according to the data length, the number of pieces of data, and the like. Therefore, the storage device of a data recording destination is determined without considering the characteristics of data.

In a case where the data recording destination is a magnetic tape, it is preferable that a plurality of pieces of data that may be relatively likely to be requested to be read within a certain period are recorded on the same magnetic tape. This is because the plurality of pieces of data can be read by single reading processing, and as a result, the reading time of the plurality of pieces of data can be shortened as compared with a case where the plurality of pieces of data are recorded on magnetic tapes different from each other.

However, since the techniques disclosed in JP2014-203329A and JP2004-252957A do not consider the probability that the plurality of pieces of data may be requested to be read within a certain period, the data reading time may be lengthened in a case where the data recording destination is the magnetic tape.

The present disclosure has been made in view of the above circumstances, and an object thereof is to provide a transfer device, a transfer method, and a transfer program capable of shortening a data reading time.

According to the present disclosure, there is provided a transfer device that distributes and transfers a plurality of pieces of data to a plurality of information processing devices that perform control to record data on a magnetic tape, the transfer device comprising: at least one processor, in which the processor transfers data to the plurality of information processing devices such that the number of pieces of data is leveled between the plurality of information processing devices, and transfers a plurality of pieces of data of which a value indicating a probability that a plurality of pieces of data are read within a predetermined period is a threshold value or greater, to the same information processing device.

In the transfer device of the present disclosure, the processor may further transfer data to the plurality of information processing devices such that a data size is leveled.

Further, in the transfer device of the present disclosure, the value indicating the probability may be a value that increases as a frequency with which the plurality of pieces of data have been read within the predetermined period in a past increases.

Alternatively, in the transfer device of the present disclosure, the value indicating the probability may be a value that increases as a frequency with which a plurality of pieces of data having the same attribute value as the plurality of pieces of data have been read within the predetermined period in a past increases.

Further, according to the present disclosure, there is provided a transfer method executed by a processor provided in a transfer device that distributes and transfers a plurality of pieces of data to a plurality of information processing devices that perform control to record data on a magnetic tape, the transfer method comprising: transferring data to the plurality of information processing devices such that the number of pieces of data is leveled between the plurality of information processing devices; and transferring a plurality of pieces of data of which a value indicating a probability that a plurality of pieces of data are read within a predetermined period is a threshold value or greater, to the same information processing device.

Further, according to the present disclosure, there is provided a transfer program for causing a processor to execute a process, the processor being provided in a transfer device that distributes and transfers a plurality of pieces of data to a plurality of information processing devices that perform control to record data on a magnetic tape, the process comprising: transferring data to the plurality of information processing devices such that the number of pieces of data is leveled between the plurality of information processing devices; and transferring a plurality of pieces of data of which a value indicating a probability that a plurality of pieces of data are read within a predetermined period is a threshold value or greater, to the same information processing device.

According to the present disclosure, it is possible to shorten a data reading time.

### BRIEF DESCRIPTION OF THE DRAWINGS

FIG. 1 is a block diagram showing an example of a configuration of a recording and reproducing system.

FIG. 2 is a diagram illustrating an object.

FIG. 3 is a block diagram showing an example of a hardware configuration of a transfer device.

FIG. 4 is a diagram showing an example of a reading log.

FIG. 5 is a block diagram showing an example of a functional configuration of the transfer device.

FIG. 6 is a diagram showing an example of a value indicating a probability that a plurality of objects may be read within a predetermined period.

FIG. 7 is a diagram illustrating transfer processing performed by the transfer device.

FIG. 8 is a flowchart showing an example of object transfer processing.

### DETAILED DESCRIPTION

Hereinafter, an example of an embodiment of the technique of the present disclosure will be described in detail with reference to the drawings.

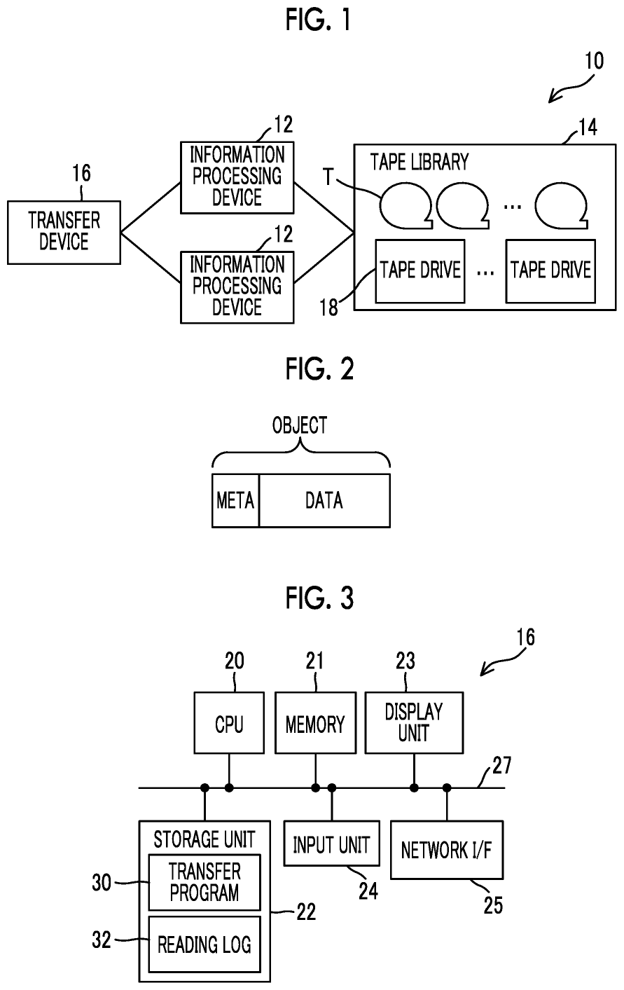

First, a configuration of a recording and reproducing system 10 according to the present embodiment will be described with reference to FIG. 1. As shown in FIG. 1, the recording and reproducing system 10 includes a plurality of (two in the present embodiment) information processing devices 12, a tape library 14, and a transfer device 16. Each information processing device 12 and the transfer device 16 are communicably connected to each other via a network. In the present embodiment, an aspect in which a system for managing medical data is applied as the recording and reproducing system 10 will be described as an example. The number of information processing devices 12 is not limited to two, and may be three or more.

The tape library 14 comprises a plurality of slots (not shown) and a plurality of tape drives 18, and a magnetic tape T as an example of a recording medium is stored in each slot. Each tape drive 18 is connected to the information processing device 12. An example of the magnetic tape T includes a linear tape-open (LTO) tape. Further, an example of the information processing device 12 includes a server computer.

In a case where the information processing device 12 writes or reads data with respect to the magnetic tape T, the magnetic tape T to be written or to be read is loaded from the slot into the predetermined tape drive 18. In a case where the writing or reading of data with respect to the magnetic tape T loaded in the tape drive 18 is completed, the magnetic tape T is unloaded from the tape drive 18 to the originally stored slot.

In the present embodiment, as shown in FIG. 2 as an example, an aspect in which an object including data to be saved by a user, such as document data and image data, and metadata related to the data is applied as a unit for handling data recorded on the magnetic tape T will be described as an example. In the example of FIG. 2, the metadata is expressed as “meta”. A storage system that handles this object is referred to as an object storage system. In the present embodiment, an aspect in which medical data conforming to a predetermined standard, such as Digital Imaging and Communications in Medicine (DICOM), is applied as data recorded on the magnetic tape T will be described as an example. The metadata includes, for example, object identification information such as an object identifier (ID), data identification information such as a data name, a data size, and attribute information such as a time stamp. The recording order of data and metadata in a case where the object is recorded on the magnetic tape T is not particularly limited, and may be the order of metadata and data, or may be the order of data and metadata.

The transfer device 16 distributes and transfers a plurality of objects to the plurality of information processing devices 12 that perform control to record an object as an example of data on the magnetic tape T. Examples of the transfer device 16 include a load balancer.

Next, the hardware configuration of the transfer device 16 according to the present embodiment will be described with reference to FIG. 3. As shown in FIG. 3, the transfer device 16 includes a central processing unit (CPU) 20, a memory 21 serving as a temporary storage area, and a non-volatile storage unit 22. Further, the transfer device 16 includes a display unit 23, such as a liquid crystal display, an input unit 24, such as a keyboard and a mouse, and a network interface (I/F) 25 connected to a network. The CPU 20, the memory 21, the storage unit 22, the display unit 23, the input unit 24, and the network I/F 25 are connected to a bus 27.

The storage unit 22 is realized by a hard disk drive (HDD), a solid state drive (SSD), a flash memory, or the like. The storage unit 22 serving as a storage medium stores a transfer program 30. The CPU 20 reads out the transfer program 30 from the storage unit 22 and then develops the transfer program 30 into the memory 21, and executes the developed transfer program 30.

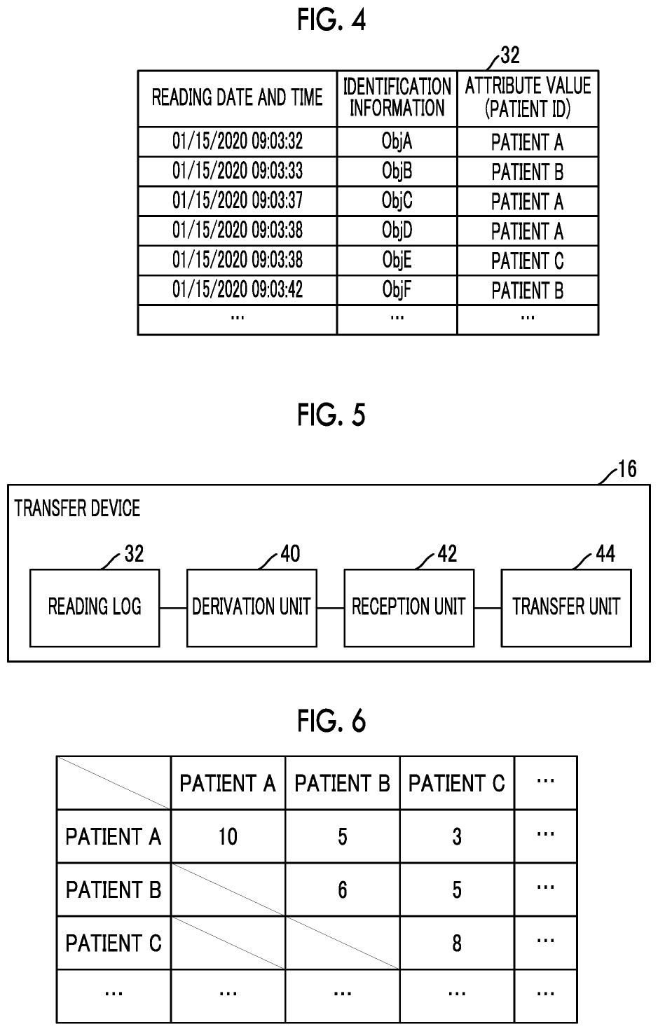

Further, the storage unit 22 stores a reading log 32 which is log data indicating a reading history of an object that has been read from a recording medium (for example, the magnetic tape T and a storage unit provided in the information processing device 12) by an instruction from a user terminal in the past. FIG. 4 shows an example of the reading log 32. As shown in FIG. 4, the reading log 32 stores the date and time when the object is read (hereinafter, referred to as “reading date and time”), identification information of the object, and an attribute value of the object. In the present embodiment, an aspect in which an attribute value of the attribute of an attribute name “patient ID” is applied as the attribute value stored in the reading log 32 will be described as an example.

Next, the functional configuration of the transfer device 16 according to the present embodiment will be described with reference to FIG. 5. As shown in FIG. 5, the transfer device 16 includes a derivation unit 40, a reception unit 42, and a transfer unit 44. The CPU 20 executes the transfer program 30 to function as the derivation unit 40, the reception unit 42, and the transfer unit 44.

The derivation unit 40 derives a value V1 indicating a probability that a plurality of objects may be read within a predetermined period T1. In the present embodiment, as the value V1, a larger value is applied as a frequency with which a plurality of objects are read within the period T1 is higher, for each combination of attribute values. As the period T1, for example, a predetermined period can be applied as a period in which a plurality of objects are assumed to be read from the magnetic tape T at one time.

Specifically, the derivation unit 40 uses the log data of the latest certain period in the reading log 32 to derive, for each combination of attribute values, the number of times that the plurality of objects having respective attribute values of the combination are read within the period T1, for each period T1, at a periodic timing, such as once a day. Further, the derivation unit 40 derives the total value of the number of times derived for each period T1 within the latest certain period, as the value V1. Then, the derivation unit 40 stores (updates) the derived value V1 in the storage unit 22. For example, the derivation unit 40 may derive the value V1 at the time when the transfer unit 44, which will be described later, transfers the plurality of objects.

FIG. 6 shows an example of the value V1. FIG. 6 shows an example in which the value V1 indicating the probability that a plurality of objects having an attribute value “patient A” may be read within the period T1 is 10. Similarly, FIG. 6 shows that the value V1 indicating that the object having an attribute value “patient A” and the object having an attribute value “patient B” may be read within the period T1 is 5. Since the same applies to combinations other than the above, such as the combination of “patient B” and “patient C”, the description thereof will be omitted. As described above, the value V1 increases as a plurality of objects have respective attribute values of a combination more frequently read in the period T1. That is, the larger the value V1 is, the higher the probability that the plurality of objects having the respective attribute values of the combination may be read at one time is. The attribute value is not limited to the patient ID, and may be, for example, the date when the object is generated, the hospital name, or a combination of a plurality of attribute values.

The reception unit 42 receives the objects transmitted from the user terminal. The transfer device 16 according to the present embodiment has a buffering function, and temporarily stores the plurality of objects received within a predetermined period, such as within 1 second, in the memory 21.

The transfer unit 44 transfers the objects to the plurality of information processing devices 12 such that the number of objects is leveled between the plurality of information processing devices 12, and transfers a plurality of objects having a value V1 equal to or greater than a threshold value to the same information processing device 12.

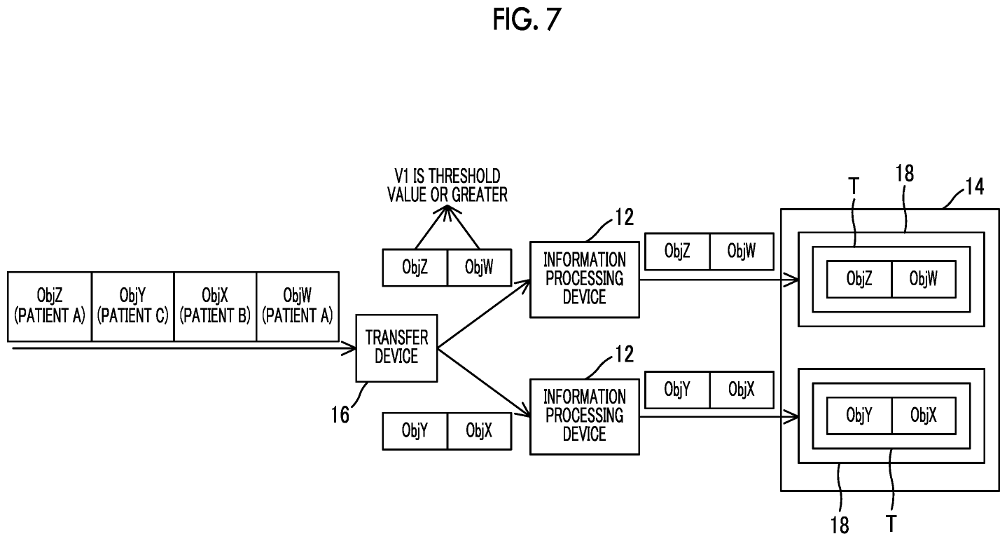

A specific example of the transfer processing performed by the transfer unit 44 will be described with reference to FIG. 7. As shown in FIG. 7, here, an example in which four objects are input to the transfer device 16 will be described. The description in parentheses in the rectangle representing an object in FIG. 7 indicates the attribute value of the object. Further, here, it is assumed that the value V1 for a plurality of objects having an attribute value of “patient A” is a threshold value or greater, and the value V1 for a plurality of objects having respective attribute values of another combination is less than the threshold value.

As shown in FIG. 7, the transfer unit 44 transfers, to the same one information processing device 12, two objects (in the example of FIG. 7, “ObjW” and “ObjZ”) of which the value V1, which is a value that increases as the frequency with which a plurality of objects having the same attribute value as “patient A” have been read within the period T1 in the past increases, is the threshold value or greater. Further, the transfer unit 44 transfers, to the remaining one information processing device 12, the remaining two objects (in the example of FIG. 7, “ObjX” and “ObjY”) such that the number of objects is leveled between the two information processing devices 12, that is, becomes the same number.

Each information processing device 12 performs control to record the plurality of objects transferred from the transfer device 16, on the same magnetic tape T. With this, a plurality of objects that are likely to be read at one time are recorded on the same magnetic tape T. On the other hand, for example, in a case where the transfer device 16 transfers a plurality of objects by using a Round-robin method, the plurality of objects that are likely to be read at one time may be recorded on magnetic tapes T different from each other. Therefore, according to the present embodiment, it is possible to shorten the data reading time while performing the load distribution.

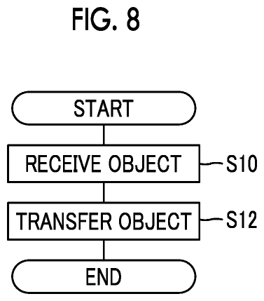

Next, the action of the transfer device 16 according to the present embodiment will be described with reference to FIG. 8. The CPU 20 executes the transfer program 30, whereby object transfer processing shown in FIG. 8 is executed. The object transfer processing shown in FIG. 8 is executed, for example, in a case where a plurality of objects transmitted from the user terminal are input to the transfer device 16.

In step S10 of FIG. 8, the reception unit 42 receives a plurality of objects transmitted from the user terminal. In step S12, the transfer unit 44 transfers the plurality of objects received in step S10 to the plurality of information processing devices 12 such that the number of objects is leveled between the plurality of information processing devices 12. At this time, as described above, the transfer unit 44 transfers, to the same information processing device 12, a plurality of objects of which the value V1, which is a value that increases as the frequency with which a plurality of objects having the same attribute value have been read within the period T1 in the past increases, is the threshold value or greater, out of all the objects received in step S10. In a case where the processing of step S12 ends, the object transfer processing ends.

As described above, according to the present embodiment, it is possible to shorten the data reading time.

In the above-described embodiment, the transfer unit 44 may further transfer the objects to the plurality of information processing devices 12 such that the size of the object is leveled.

Further, in the above-described embodiment, the case where a value that increases as the frequency with which a plurality of objects having the same attribute value as the object to be transferred have been read within the predetermined period T1 in the past increases is applied as the value V1 has been described, but the present disclosure is not limited thereto. For example, a value that increases as the frequency with which a plurality of objects to be transferred have been read within the predetermined period T1 in the past increases may be applied as the value V1. In this case, in the example of FIG. 7, the derivation unit 40 need only derive the number of times that two objects having the same identification information, out of the four objects, are read within the period T1, as the value V1, by referring to the reading log 32 for each combination of the two objects.

In the above-described embodiment, the case where the disclosed technique is applied to the object storage system has been described, but the present disclosure is not limited thereto. The disclosed technique may be applied to a file storage system that handles data as a file unit.

Further, in the above-described embodiment, for example, as a hardware structure of a processing unit that executes various types of processing, such as the derivation unit 40, the reception unit 42, and the transfer unit 44, the following various processors can be used. The above-described various processors include, for example, a programmable logic device (PLD) which is a processor having a changeable circuit configuration after manufacture, such as a field programmable gate array (FPGA), and a dedicated electrical circuit which is a processor having a dedicated circuit configuration designed to perform specific processing, such as an application specific integrated circuit (ASIC), in addition to the CPU which is a general-purpose processor that executes software (programs) to function as various processing units, as described above.

One processing unit may be composed of one of these various processors or a combination of two or more processors of the same type or different types (for example, a combination of a plurality of FPGAs or a combination of a CPU and an FPGA). Alternatively, a plurality of processing units may be composed of one processor.

A first example in which a plurality of processing units are composed of one processor is an aspect in which one or more CPUs and software are combined to constitute one processor and the processor functions as the plurality of processing units, as typified by a computer, such as a client and a server. A second example is an aspect in which a processor that realizes all the functions of a system including the plurality of processing units with one integrated circuit (IC) chip is used, as typified by a system on chip (SoC). As described above, various processing units are formed of one or more of the above-described various processors as the hardware structure.

Further, as the hardware structure of these various processors, more specifically, an electric circuit (circuitry) in which circuit elements, such as semiconductor elements, are combined can be used.

In the above-described embodiment, the aspect in which the transfer program 30 is stored (installed) in the storage unit 22 in advance has been described, but the present disclosure is not limited thereto. The transfer program 30 may be provided in a form of being recorded on a recording medium, such as a compact disc read only memory (CD-ROM), a digital versatile disc read only memory (DVD-ROM), and a Universal Serial Bus (USB) memory. Alternatively, the transfer program 30 may be downloaded from an external device via the network.

The disclosure of JP2020-044486 filed on Mar. 13, 2020 is incorporated herein by reference in its entirety. In addition, all documents, patent applications, and technical standards described in the present specification are incorporated herein by reference to the same extent as in a case of being specifically and individually noted that individual documents, patent applications, and technical standards are incorporated by reference.

What is claimed is:

1. A transfer device that distributes and transfers a plurality of pieces of data to a plurality of information processing devices that perform control to record data on a magnetic tape, the transfer device comprising:
at least one processor,
wherein the processor
transfers data to the plurality of information processing devices such that the number of pieces of data is leveled between the plurality of information processing devices, and
transfers a plurality of pieces of data of which a value indicating a probability that a plurality of pieces of data are read within a predetermined period is a threshold value or greater, to the same information processing device.

2. The transfer device according to claim 1,
wherein the processor further transfers data to the plurality of information processing devices such that a data size is leveled.

3. The transfer device according to claim 1,
wherein the value indicating the probability is a value that increases as a frequency with which the plurality of pieces of data have been read within the predetermined period in a past increases.

4. The transfer device according to claim 1,
wherein the value indicating the probability is a value that increases as a frequency with which a plurality of pieces of data having the same attribute value as the plurality of pieces of data have been read within the predetermined period in a past increases.

5. The transfer device according to claim 2,
wherein the value indicating the probability is a value that increases as a frequency with which the plurality of pieces of data have been read within the predetermined period in a past increases.

6. The transfer device according to claim 2,
wherein the value indicating the probability is a value that increases as a frequency with which a plurality of pieces of data having the same attribute value as the plurality of pieces of data have been read within the predetermined period in a past increases.

7. The transfer device according to claim 3,
wherein the value indicating the probability is a value that increases as a frequency with which a plurality of pieces of data having the same attribute value as the plurality of pieces of data have been read within the predetermined period in a past increases.

8. The transfer device according to claim 5,
wherein the value indicating the probability is a value that increases as a frequency with which a plurality of pieces of data having the same attribute value as the plurality of pieces of data have been read within the predetermined period in a past increases.

9. A transfer method executed by a processor provided in a transfer device that distributes and transfers a plurality of pieces of data to a plurality of information processing devices that perform control to record data on a magnetic tape, the transfer method comprising:
transferring data to the plurality of information processing devices such that the number of pieces of data is leveled between the plurality of information processing devices; and
transferring a plurality of pieces of data of which a value indicating a probability that a plurality of pieces of data are read within a predetermined period is a threshold value or greater, to the same information processing device.

10. A non-transitory computer-readable storage medium storing a transfer program for causing a processor to execute a process, the processor being provided in a transfer device that distributes and transfers a plurality of pieces of data to a plurality of information processing devices that perform control to record data on a magnetic tape, the process comprising:
transferring data to the plurality of information processing devices such that the number of pieces of data is leveled between the plurality of information processing devices; and
transferring a plurality of pieces of data of which a value indicating a probability that a plurality of pieces of data are read within a predetermined period is a threshold value or greater, to the same information processing device.
